(19) United States
(12) Patent Application Publication
(10) Pub. No.: US 2012/0131275 A1
(43) Pub. Date: May 24, 2012

(54) NETWORK-ATTACHED STORAGE SYSTEM

(75) Inventors: Frank Huang, Hsin-Chu (TW); Hung-Ming Chien, Hsin-Chu (TW); Cheng-Yi Huang, Hsin-Chu (TW); Ying-Tse Kuo, Hsin-Chu (TW)

(73) Assignee: PROMISE TECHNOLOGY, INC, Hsin-Chu (TW)

(21) Appl. No.: 13/087,396

(22) Filed: Apr. 15, 2011

(30) Foreign Application Priority Data
Nov. 18, 2010 (TW) 099139626

(51) Int. Cl. G06F 12/16

(52) U.S. Cl. 711/114; 711/154; 711/E12.103

(57) ABSTRACT

The invention discloses a network-attached storage system including an interface module, a plurality of storage devices and a storage module. The interface module is configured to be attached to a network. The interface module is for receiving a transmission protocol information transmitted over the network, and processing the information into storage data and access instructions. The storage module is for receiving the storage data and the access instructions, and controlling, according to the access instructions, access of the storage data to the primary storage devices through a transmission interface.

### CROSS-REFERENCE TO RELATED APPLICATION

This utility application claims priority to Taiwan Application Serial Number 099139626, filed Nov. 18, 2010, which is incorporated herein by reference.

### BACKGROUND OF THE INVENTION

1. Field of the Invention

The invention relates to a network-attached storage system and, more in particular, to a network-attached storage system capable of being attached to a network conveniently.

2. Description of the Prior Art

It becomes the trend that a large number of data is stored in the remote and the access of data is performed via a network. There are different approaches developed how to save important data stored in data storage systems if abnormalities or errors occur.

One of the approaches is to utilize Redundant Array of Independent Drives (RAID) systems to store a large amount of digital data. RAID systems are able to provide high availability, high performance, or high volume of data storage volume for hosts.

Constitution of a well-known RAID system includes a RAID controller and a RAID composed of a plurality of disk drives. The RAID controller is coupled to each disk drive, and defines the disk drives as one or more logical disk drives selected among RAID 0, RAID 1, RAID 2, RAID 3, RAID 4, RAID 5, RAID 6, and others. The RAID controller is respectively coupled to each of the disk drives, and functions controlling access of data to the disk drives. The RAID controller can also generate (re-construct) redundant data which are identical to data to be read. The RAID controller can generate redundant data by Exclusive OR (XOR) operation or other equivalent operation. When the RAID system fails, the RAID controller can calculate the data previously stored in the failed RAID system by use of redundant data.

Another of the approaches is to utilize several storage systems which each has clustered storage devices, for example, as shown in FIG. 1, a storage system 2a, a storage system 2b and storage system 2c attached to a network 1. These clustered storage devices can be specified in JBOD (Just a Bunch Of Disks) architecture.

As shown in FIG. 1, the storage system 2a, the storage system 2b and the storage system 2c all are attached to the network 1. The storage system 2a includes a server 20a, a storage controller 22a and a plurality of storage devices 24a. The server 20a is linked to the network 1, and in charge of processing transmission of information complying with for example iSCSI and translation between stored data and access instructions. The storage controller 22a then controls access of stored data to the plurality of storage devices 24a in accordance with the access instructions. Similarly, the storage system 2b includes a server 20b, a storage controller 22b and a plurality of storage devices 24b. The server 20b is linked to the network 1, and in charge of processing transmission of information and translation between stored data and access instructions. Then, the storage controller 22b controls access of stored data to the plurality of storage devices 24b in accordance with the access instructions. Similarly, the storage system 2c includes a server 20c, a storage controller 22c and a plurality of storage devices 24c. The server 20c is linked to the network 1, and in charge of processing transmission of information and translation between stored data and access instructions. The storage controller 22c then controls access of stored data to the plurality of storage devices 24c in accordance with the access instructions.

The same data has copies stored in the storage system 2a, the storage system 2b and storage system 2c. The access of data over the network 1 is first performed for the storage system 2a. If abnormalities or failure occur in the storage system 2a, the access of data over the network 1 is turned to the storage system 2b in the near of the storage system 2a. If abnormalities or failure also occur in the storage system 2b, the access of data over the network 1 is turned to the storage system 2c in the remote of the storage system 2a.

Obviously, due to disadvantage of complicated architecture, the storage systems including clustered storage devices of the prior arts cannot be attached to network conveniently. In addition, there are no approaches proposed for the storage systems including clustered storage devices of the prior arts to ensure safety of stored data and manage power of the storage systems.

### SUMMARY OF THE INVENTION

Accordingly, one scope of the invention is to provide a network-attached storage system. Moreover, in particular, the network-attached storage system according to the invention can be attached to a network conveniently.

Another scope of the invention is to provide a network-attached storage system. Moreover, in particular, the network-attached storage system can record abnormalities occurring in internal storage devices, ensure safety of stored data, and save power consumption.

A network-attached storage system according to a preferred embodiment of the invention includes an interface module, a plurality of primary storage devices and a storage module. The interface module is configured to be attached to a network. The interface module functions receiving information complying with a transmission protocol and transmitted over the network, and processing the received information into storage data and access instructions. The storage module is respectively coupled to the interface module and each of the primary storage devices. The storage module functions receiving the storage data and the access instructions, and controlling, according to the access instructions, access of the storage data to the primary storage devices through a transmission interface. The interface module also receives the storage data and the access instructions transmitted by the storage module, and processes the storage data and the access instructions into the information. Moreover, the interface module transmits the processed information to the network.

In one embodiment, the transmission protocol can be TCP/IP (Transmission Control Protocol over Internet Protocol), iSCSI (Internet Small Computer Systems Interface) protocol, FCoE (Fibre Channel over Ethernet) protocol, HDFS (Hadoop Distributed File System) protocol, Lustre File System protocol, NFS (Network File System) protocol, SNMP (Simple Network Management Protocol), or other protocols or file systems constructed on Ethernet.

In one embodiment, the transmission interface can be FC (Fiber Channel), SCSI (Small Computer Systems Interface), SAS, SATA, PATA, InfiniBand interface, or other transmission interfaces used in storage field.

A network-attached storage system according to another preferred embodiment of the invention further includes an intelligent module. The intelligent module is coupled between the interface module and the storage module. The intelligent module functions monitoring communication between the interface module and the storage module, which includes abnormalities occurring in the communication.

A network-attached storage system according to another preferred embodiment of the invention further includes at least one spare storage device. The at least one spare storage device is coupled to the storage module. The storage module replaces, based on the result monitored by the intelligent module, one of the primary storage devices with one of the at least one spare storage device by copying data stored in said one primary storage device into said one spare storage device.

In one embodiment, each of the primary storage devices can be a tape drive, a disk drive, a memory device, an optical storage drive, or other equivalent storage devices.

The advantage and spirit of the invention may be understood by the following recitations together with the appended drawings.

### BRIEF DESCRIPTION OF THE APPENDED DRAWINGS

FIG. 1 is a schematic diagram showing the architecture of a conventional storage system using several clustered storage devices and accessing data over a network.

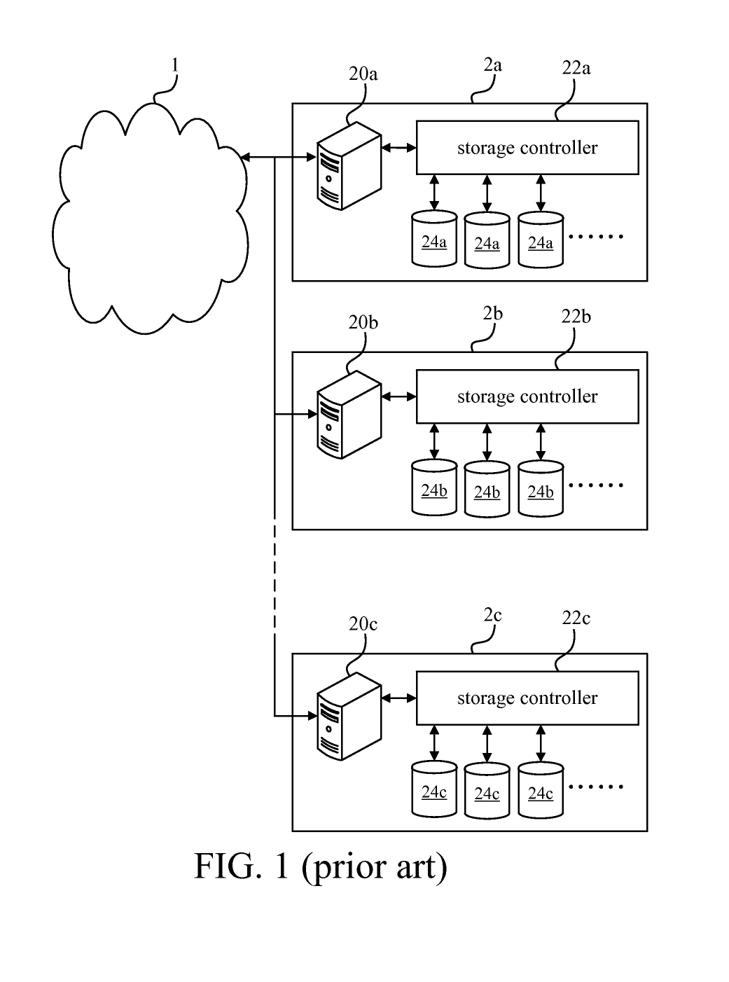

FIG. 2 is a schematic diagram showing the architecture of a network-attached storage system according to a preferred embodiment of the invention.

### DETAILED DESCRIPTION OF THE INVENTION

The invention is to provide a network-attached storage system. In particular, the network-attached storage system according to the invention can be attached to a network conveniently, and further can record abnormalities occurring in internal data transmission, ensure safety of stored data, and save power consumption. Some preferred embodiments and practical applications of this present invention would be explained in the following paragraph, describing the characteristics, spirit, advantages of the invention, and feasibility of embodiment.

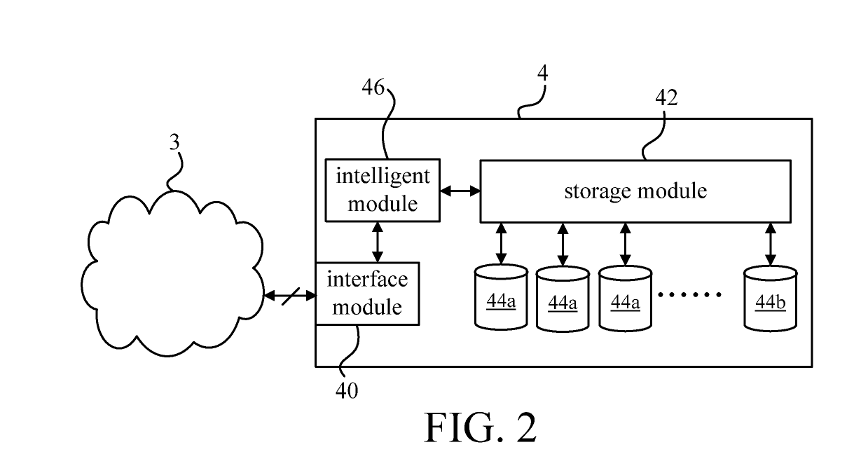

Referring to FIG. 2, the architecture of a network-attached storage system 4 according to a preferred embodiment of the invention is illustratively shown in FIG. 2. The network-attached storage system 4 can be attached to a network 3 conveniently.

As shown in FIG. 2, the network-attached storage system 4 includes an interface module 40, a plurality of primary storage devices 44a and a storage controller 42. The interface module 40 is configured to be attached to the network 3.

The interface module 40 functions receiving information complying with a transmission protocol and transmitted over the network 3, and processing the received information into storage data and access instructions.

In one embodiment, the transmission protocol can be TCP/IP (Transmission Control Protocol over Internet Protocol), iSCSI (Internet Small Computer Systems Interface) protocol, FCoE (Fibre Channel over Ethernet) protocol, HDFS (Hadoop Distributed File System) protocol, Lustre File System protocol, NFS (Network File System) protocol, SNMP (Simple Network Management Protocol), or other protocols or file systems constructed on Ethernet. It needs to be noticed that the connection between the interface module 40 and the network 3 is not limited in a cable, also can be constructed by a plurality of cables which each is in charge of transmitting information complying with one of the transmission protocols mentioned-above.

The storage module 42 is respectively coupled to the interface module 40 and each of the primary storage devices 44a. The storage module 42 functions receiving the storage data and the access instructions, and controlling, according to the access instructions, access of the storage data to the primary storage devices 44a through a transmission interface.

In one embodiment, each of the primary storage devices 44a can be a tape drive, a disk drive, a memory device, an optical storage drive, or other equivalent storage devices.

In practical application, the plurality of storage devices 44a can be specified in JBOD (Just a Bunch Of Disks) architecture.

In practice, the transmission interface can be FC (Fiber Channel), SCSI (Small Computer Systems Interface), SAS, SATA, PATA, InfiniBand interface, or other transmission interfaces used in storage field.

The interface module 40 also receives the storage data and the access instructions transmitted by the storage module 42, and processes the storage data and the access instructions into the information. Moreover, the interface module 40 transmits the processed information to the network 3.

Also shown in FIG. 2, a network-attached storage system 4 according to another preferred embodiment of the invention further includes an intelligent module 46. The intelligent module 46 is coupled between the interface module 40 and the storage module 42. In particular, the intelligent module 46 functions monitoring communication between the interface module 40 and the storage module 42, which includes abnormalities occurring in the communication such as too long time of data access and so on.

Also shown in FIG. 2, a network-attached storage system 4 according to another preferred embodiment of the invention further includes at least one spare storage device 44b. In this case shown in FIG. 2, it only illustratively shows a spare storage device 44b as an example for explanation. The at least one spare storage device 44b is coupled to the storage module 42. The storage module 42 replaces one of the primary storage devices 44a with one of the at least one spare storage device 44b by copying data stored in said one primary storage device 44a into said one spare storage device 44b on the basis of the result monitored by the intelligent module 46, e.g., number or frequency of abnormality occurring in the primary storage devices 44a. Thereby, the network-attached storage system 4 can previously copy data stored in unhealthy primary storage device 44a into the spare storage device 44b to ensure the safety of stored data before the unhealthy primary storage device 44a fails.

In addition, the storage module 42 controls, based on the result monitored by the intelligent module 46, power of one of the plurality of primary storage devices 44a in one of at least two power operation modes, such as active mode, power-saving mode and so on. Thereby, the network-attached storage system 4 according to the invention can confirm the primary storage system 44a seldom used, and switch the operation of the primary storage system 44a seldom used into the power-saving mode to reduce power consumption of the whole of storage system. Regarding controlling of the spare storage system 44b, the spare storage system 44b is controlled in the power-saving mode when not used, and switched into the active mode when used to copy data and replace the unhealthy primary storage device 44a.

In practical application, the interface 40, the storage module 42 and the intelligent module 46 can be implemented into a single chip, and also can be implemented into an SoC (system-on-a-chip).

With the detailed description of the above preferred embodiments of the invention, it is clear to understand that the network-attached storage system provided by the invention can be attached to a network conveniently, and can record abnormalities occurring in internal data transmission, ensure safety of stored data, and save power consumption.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A network-attached storage system, comprising:
an interface device, configured to be attached to a network, for receiving information complying with a transmission protocol and transmitted over the network, and processing the received information into storage data and access instructions;
a plurality of primary storage devices; and
a storage module, respectively coupled to the interface device and each primary storage device, for receiving the storage data and the access instructions, and controlling, according to the access instructions, access of the storage data to the primary storage devices through a transmission interface, wherein the interface module also receives the storage data and the access instructions transmitted by the storage module, processes the storage data and the access instructions into the information, and transmits the processed information to the network.

2. The network-attached storage system of claim 1, wherein the plurality of storage devices are specified in JBOD (Just a Bunch Of Disks) architecture.

3. The network-attached storage stem of claim 2, wherein the transmission protocol is one selected from the group consisting of TCP/IP (Transmission Control Protocol over Internet Protocol), iSCSI (Internet Small Computer Systems Interface) protocol, FCoE (Fibre Channel over Ethernet) protocol, HDFS (Hadoop Distributed File System) protocol, Lustre File System protocol, NFS (Network File System) protocol and SNMP (Simple Network Management Protocol).

4. The network-attached storage system of claim 3, wherein the transmission interface is one selected from the group consisting of FC (Fiber Channel), SCSI (Small Computer Systems Interface), SAS, SATA, PATA and InfiniBand interface.

5. The network-attached storage system of claim 4, further comprising an intelligent module, coupled between the interface module and the storage module, for monitoring communication between the interface module and the storage module.

6. The network-attached storage system of claim 5, further comprising at least one spare storage device coupled to the storage module, wherein the storage module replaces, based on the result monitored by the intelligent module, one of the primary storage devices with one of the at least one spare storage device by copying data stored in said one primary storage device into said one spare storage device.

7. The network-attached storage system of claim 5, wherein the storage module controls power of one of the plurality of primary storage devices in one of at least two power operation modes on the basis of the result monitored by the intelligent module.

8. The network-attached storage system of claim 5, wherein the storage module controls power of one of the at least one storage device in one of at least two power operation modes on the basis of the result monitored by the intelligent module.

9. The network-attached storage system of claim 5, wherein each of the primary storage devices is one selected from the group consisting of a tape drive, a disk drive, a memory device and an optical storage drive.
